(19) United States
(12) Patent Application Publication
(10) Pub. No.: US 2013/0188111 A1
(43) Pub. Date: Jul. 25, 2013

(54) LIQUID CRYSTAL DISPLAY DEVICE AND MANUFACTURING METHOD THEREOF

(71) Applicants: Takeo Koito, Kanagawa (JP); Daisuke Takama, Kanagawa (JP)

(72) Inventors: Takeo Koito, Kanagawa (JP); Daisuke Takama, Kanagawa (JP)

(73) Assignee: JAPAN DISPLAY WEST INC., Aichi-Ken (JP)

(21) Appl. No.: 13/561,920

(22) Filed: Jul. 30, 2012

(30) Foreign Application Priority Data
Aug. 2, 2011 (JP) 2011-169344

(51) Int. Cl. G02F 1/1341; G02F 1/1333

(52) U.S. Cl. CPC G02F 1/1341; G02F 1/1333
USPC 349/58; 445/24; 445/25

(57) ABSTRACT

Disclosed herein is a liquid crystal display device and a manufacturing method thereof. The liquid crystal display device includes: a display section having a liquid crystal layer between a pair of substrates; and a frame section provided at a peripheral part of the pair of substrates. The frame section has an inlet for liquid crystal injection and the inlet is provided in a continuous linear manner. The manufacturing method of the liquid crystal display device, includes: providing an inlet in a continuous linear manner in the frame section; and injecting a liquid crystal from the inlet into a gap between the pair of substrates.

### CROSS REFERENCES TO RELATED APPLICATIONS

The present application claims priority to Japanese Priority Patent Application JP 2011-169344 filed in the Japan Patent Office on Aug. 2, 2011, the entire content of which is hereby incorporated by reference.

### BACKGROUND

The present disclosure relates to a liquid crystal display device suitable for reduction in the frame size and a manufacturing method thereof

In the liquid crystal display device, a sealing frame is provided outside the display section. After a liquid crystal is injected from an inlet of this sealing frame, a sealing material is packed into the inlet and the inlet is closed. If the frame size becomes small, packing control of the sealing material becomes difficult and possibly the sealing material affects the display area. Therefore, when the frame size is small, a method of dropping injection of the liquid crystal will be advantageous as described in e.g. Japanese Patent Laid-open No. 2005-338886.

However, using the method of dropping injection leads to e.g. the following problems: new facilities are necessary; the width of the sealing frame cannot be decreased; and the liquid crystal gets contact with the sealing frame before baking and therefore the influence on the reliability is large.

As a countermeasure, it is proposed to scribe the substrate base material together with the sealing frame as described in e.g. Japanese Patent Laid-open No. 2008-175944. In addition, the related art of the present disclosure is described in Japanese Patent Laid-open No. 2009-145442 and Japanese Patent Laid-open No. 2010-44136.

### SUMMARY

However, in the related-art method of the above-mentioned Japanese Patent Laid-open No. 2008-175944, the scribing accuracy (breaking accuracy) needs to be considered in addition to the positional accuracy of the sealing frame. Therefore, it is difficult to apply this method to an actual mass-production step in terms of the reliability.

There is a need for the present disclosure to provide a liquid crystal display device that allows reduction in the frame size and ensuring of the reliability and a manufacturing method thereof.

According to an embodiment of the present disclosure, there is provided a liquid crystal display device including a display section configured to have a liquid crystal layer between a pair of substrates and a frame section configured to be provided at a peripheral part of the pair of substrates. The frame section has an inlet for liquid crystal injection and the inlet is provided in a continuous linear manner.

The “continuous linear manner” means that the inlet is equivalent to or larger than one side of the display section in size if the pair of substrates each have a rectangular shape (quadrangular shape) or another polygonal shape for example. Furthermore, it means that the inlet occupies at least one-fifth of the outer shape line of the pair of substrates if the pair of substrates each have a curved-line shape such as a circular shape or another indefinite shape.

In the liquid crystal display device of the embodiment of the present disclosure, the inlet is provided in a continuous linear manner. Therefore, the inlet is wide and a sealing frame does not need to be provided at this part. Accordingly, the frame size is reduced corresponding to the absence of the sealing frame. In addition, reliability lowering due to superposition of the positional accuracy of the sealing frame and the scribing accuracy (breaking accuracy) is suppressed.

According to another embodiment of the present disclosure, there is provided a manufacturing method of a liquid crystal display device including a display section having a liquid crystal layer between a pair of substrates and a frame section provided at a peripheral part of the pair of substrates. The method includes providing an inlet in a continuous linear manner in the frame section and injecting a liquid crystal from the inlet into a gap between the pair of substrates.

According to the liquid crystal display device in accordance with the embodiment of the present disclosure or the manufacturing method of a liquid crystal display device in accordance with the embodiment of the present disclosure, reduction in the frame size and ensuring of the reliability are enabled because the inlet is provided in a continuous linear manner.

Additional features and advantages are described herein, and will be apparent from the following Detailed Description and the figures.

### BRIEF DESCRIPTION OF THE FIGURES

FIG. 1 is a top view showing the configuration of a liquid crystal display device according to a first embodiment of the present disclosure;

FIG. 2 is a sectional view showing one example of the configuration along line II-II in FIG. 1;

FIG. 3 is a sectional view along line in FIG. 1;

FIGS. 4A and 4B are a top view showing the major part of a manufacturing method of the liquid crystal display device shown in FIG. 1 in the step order;

FIG. 5 is a top view showing the configuration of a liquid crystal display device of a related art;

FIG. 6 is a top view showing the configuration of a liquid crystal display device according to a second embodiment of the present disclosure;

FIG. 7 is a sectional view showing one example of the configuration along line VII-VII in FIG. 6;

FIG. 8 is a sectional view along line VIII-VIII in FIG. 6;

FIG. 9 is a sectional view showing another example of the configuration along line VII-VII in FIG. 6;

FIG. 10 is a top view for explaining the state in which a sealing material is stopped at a gap shown in FIG. 9;

FIGS. 11A and 11B are a top view showing the major part of a manufacturing method of the liquid crystal display device shown in FIG. 6 in the step order;

FIG. 12 is a top view showing the configuration of a weir structure of a liquid crystal display device according to modification example 1;

FIG. 13 is a top view showing the configuration of a weir structure of a liquid crystal display device according to modification example 2;

FIG. 14 is a sectional view along line XIV-XIV in FIG. 13;

FIG. 15 is a top view showing the configuration of a weir structure of a liquid crystal display device according to modification example 3;

FIG. 16 is a top view showing the configuration of a weir structure of a liquid crystal display device according to modification example 4;

FIG. 17 is a top view showing the configuration of a weir structure of a liquid crystal display device according to modification example 5;

FIG. 18 is a top view showing the configuration of a weir structure of a liquid crystal display device according to modification example 6;

FIG. 19 is a top view showing the configuration of a weir structure of a liquid crystal display device according to modification example 7;

FIG. 20 is a top view showing the configuration of a weir structure of a liquid crystal display device according to modification example 8;

FIG. 21 is a top view showing the configuration of a weir structure of a liquid crystal display device according to modification example 9;

FIG. 22 is a top view showing the configuration of a liquid crystal display device according to modification example 10;

FIGS. 23A and 23B are a side view showing the major part of a manufacturing method of the liquid crystal display device shown in FIG. 22 in the step order;

FIG. 24 is a top view showing the configuration of a liquid crystal display device according to modification example 11;

FIG. 25 is a top view showing the configuration of a liquid crystal display device according to modification example 12;

FIG. 26 is a top view showing the configuration of a liquid crystal display device according to modification example 13;

FIG. 27 is a top view showing the configuration of a liquid crystal display device according to modification example 14;

FIG. 28 is a top view showing the configuration of a liquid crystal display device according to modification example 15;

FIG. 29 is a top view showing a modification example of FIG. 28; and

FIG. 30 is a top view showing another modification example of FIG. 28.

### DETAILED DESCRIPTION

Embodiments of the present disclosure will be described in detail later with reference to the drawings. The order of the description is as follows:
1. First Embodiment (example in which an inlet is provided across the whole of the upper side of the display section)
2. Second Embodiment (example in which a weir structure is provided between an inlet and the display section in such a manner as to surround the upper side of the display section and corners at both ends thereof)
3. Modification Example 1 (example in which a weir structure is provided along only the upper side of the display section)
4. Modification Example 2 (example in which the end parts of a sealing frame overlap with the end parts of a weir structure)
5. Modification Example 3 (example in which a weir structure is doubly disposed)
6. Modification Example 4 (example in which a weir structure is configured by plural walls provided along a direction that is not perpendicular to the entry direction of a sealing material)
7. Modification Example 5 (example in which the ends of a sealing frame are made to recede from the outer shape line of first substrate and second substrate)
8. Modification Example 6 (example in which the ends of a sealing frame are formed into a shape other than the straight line)
9. Modification Example 7 (example in which a weir structure is configured by the same layer as a spacer layer of the display section)
10. Modification Example 8 (example in which a weir structure is configured by the same layer as an organic insulating layer and the same layer as a spacer layer)
11. Modification Example 9 (example in which a weir structure is configured by stacking color filters of two colors)
12. Modification Example 10 (example in which a light window is provided on a side surface instead of a weir structure)
13. Modification Example 11 (example in which an inlet is provided across the whole of the lower side of the display section)
14. Modification Example 12 (example in which an inlet is provided across the whole of the left side of the display section)
15. Modification Example 13 (example in which an inlet is provided across the whole of the right side of the display section)
16. Modification Example 14 (example in which the display section has a hexagonal shape)
17. Modification Example 15 (example in which the display section has a circular shape)

### First Embodiment

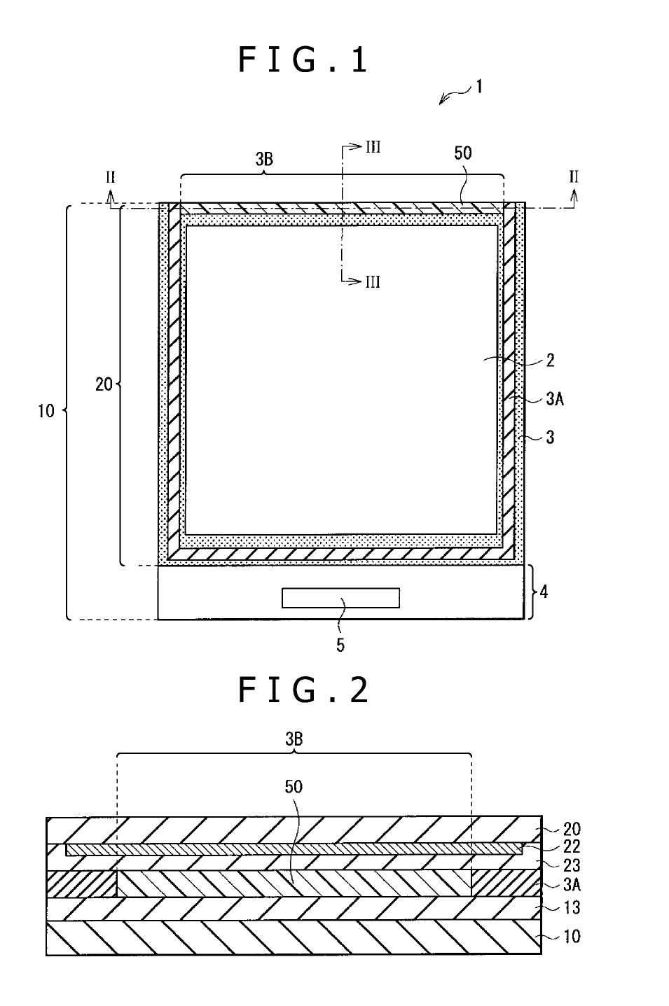

FIG. 1 shows the whole configuration of a liquid crystal display device according to a first embodiment of the present disclosure. This liquid crystal display device 1 is used for e.g. a cellular phone or a smartphone. The liquid crystal display device 1 has a display section 2 and a frame section 3 around the display section 2.

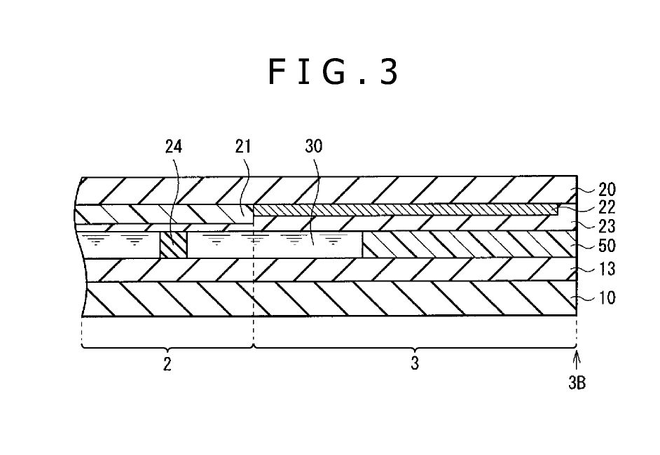

The display section 2 has a liquid crystal layer 30 (not shown in FIG. 1, see FIG. 3) between one pair of substrates (first substrate 10 and second substrate 20) composed of e.g. glass. In the display section 2, plural pixels (not shown) formed of liquid crystal display elements are disposed in a matrix manner.

The frame section 3 is a frame-like area surrounding the display section 2 at the peripheral part of the first substrate 10 and the second substrate 20. In the frame section 3, a sealing frame 3A composed mainly of e.g. a thermosetting resin is so provided as to surround the display section 2. The sealing frame 3A has an inlet 3B for liquid crystal injection and this inlet 3B is provided in a continuous linear manner. This enables reduction in the frame size and ensuring of the reliability in this liquid crystal display device 1.

The following configuration is preferable. Specifically, for example as shown in FIG. 1, the first substrate 10 and the second substrate 20 each have a rectangular shape and the display section 2 is a rectangular area at the center part of the first substrate 10 and the second substrate 20. In addition, the inlet 3B is provided along the whole of one side (e.g. upper side, in FIG. 1) of the display section 2. That is, if the first substrate 10 and the second substrate 20 each have a rectangular shape (quadrangular shape), it is preferable for the inlet 3B to be equivalent to or larger than one side of the display section 2 in size.

It is preferable for the inlet 3B to be provided along the upper sides or left or right sides of the first substrate 10 and the second substrate 20. The reason for this is as follows. Along one side (e.g. lower side, in FIG. 1) of the first substrate 10, an exposed area 4 protruded out from the second substrate 20 is provided. An external connection terminal 5 is provided in this exposed area 4 by extending wiring of signal line drive circuit and scan line drive circuit (neither is shown) on the first substrate 10. Due to the provision of the inlet 3B along the upper sides or left or right sides of the first substrate 10 and the second substrate 20, it becomes less likely that the liquid crystal and so forth injected from the inlet 3B gets contact with the external connection terminal 5, so that the reliability of the external connection terminal 5 can be enhanced.

The inlet 3B is filled with a sealing material 50. The sealing material 50 blocks the inlet 3B and seals the liquid crystal in the display section 2. It is configured by e.g. an ultraviolet-curable resin. The sealing material 50 is buried to a position at a distance of e.g. about 50 μm from the inlet 3B in order to suppress the entry of water and so forth.

FIG. 2 shows a sectional configuration along line II-II in FIG. 1 and FIG. 3 shows a sectional configuration along line in FIG. 1. Over the first substrate 10 of the display section 2, e.g. a metal wiring layer (not shown), an organic insulating layer 13 as a planarization layer, a common electrode (not shown), an interlayer insulating film (not shown), pixel electrodes (not shown), and an alignment film (not shown) are provided in that order from the side of the first substrate 10. That is, this display section 2 has e.g. a so-called fringe field switching (FFS) configuration.

Over the second substrate 20 of the display section 2, e.g. a color filter 21, a light blocking film 22 as a black matrix, an overcoat layer 23 as a planarization layer, a spacer layer 24, and an alignment film (not shown) are provided in that order from the side of the second substrate 20. The liquid crystal layer 30 is provided between the first substrate 10 and the second substrate 20. Polarizing plates and so forth (not shown) are bonded to the outside of the first substrate 10 and the second substrate 20. A backlight unit (not shown) composed of a light source, a light guide plate, and so forth is disposed on the backside of the first substrate 10.

This liquid crystal display device 1 can be manufactured in the following manner for example.

First, the first substrate 10 composed of e.g. glass is prepared and a drive circuit (not shown) formed of TFTs and so forth and the metal wiring layer (not shown) are formed in the display section 2 of this first substrate 10. Subsequently, the drive circuit and the metal wiring layer are covered by the organic insulating layer 13 to planarize the surface of the display section 2. Thereafter, the common electrode, the interlayer insulating film, and the pixel electrodes (none are shown) are sequentially formed over the organic insulating layer 13. Subsequently, the alignment film (not shown) is formed over the first substrate 10.

Furthermore, the second substrate 20 composed of e.g. glass is prepared and the color filter 21 and the light blocking film 22 are formed over this second substrate 20. Then, the second substrate 20 is covered by the overcoat layer 23. Subsequently, the spacer layer 24 is formed in the display section 2 of the second substrate 20 and the alignment film (not shown) is formed.

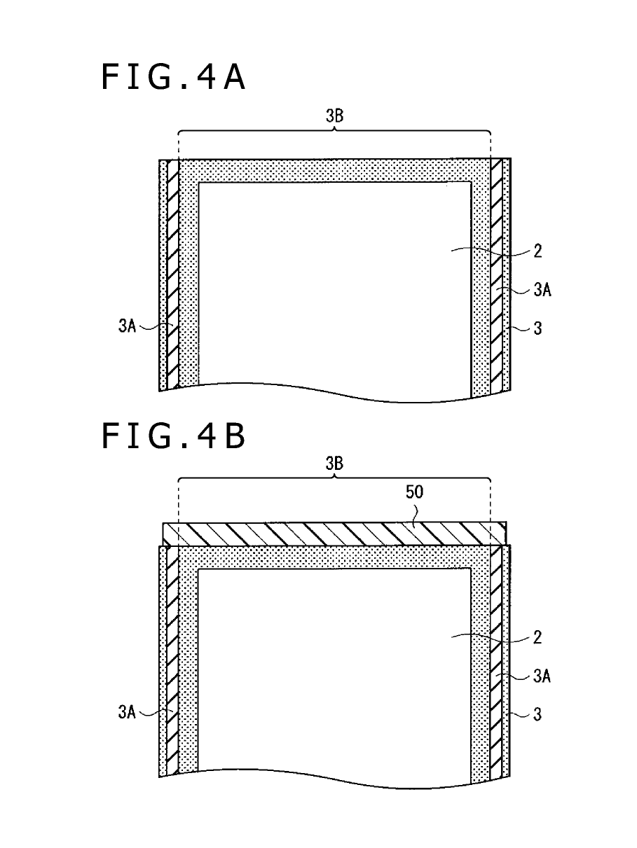

Subsequently, as shown in FIG. 4A, the sealing frame 3A is formed by a thermosetting resin in the frame section 3 of the first substrate 10 for example. The sealing frame 3A is formed into a shape of a rectangular frame surrounding the display section 2. In addition, an opening is left along one side of the first substrate 10 and this opening is used as the inlet 3B.

Thereafter, the first substrate 10 and the second substrate 20 are disposed opposed to each other with the intermediary of the sealing frame 3A and bonding of the first substrate 10 and the second substrate 20 is performed by curing the thermosetting resin configuring the sealing frame 3A.

Subsequently, the first substrate 10 and the second substrate 20 are cut (scribed and broken) into predetermined size. In the case of a middle- or small-size display device, the plural display sections 2 are arranged (multiple-panel arrangement) in a mother substrate (not shown). Thus, for example, each display section 2 is so separated that the state in which the inlet 3B is exposed to the outer end is obtained (single-piece injection). Thereafter, a liquid crystal is injected from the inlet 3B into the gap between the first substrate 10 and the second substrate 20. The liquid crystal passes through the inlet 3B to be introduced to the display section 2.

Thereafter, as shown in FIG. 4B, the sealing material 50 is applied to the inlet 3B in the state in which the pressure of the inside of the sealing frame 3A is reduced, and the sealing material 50 is drawn from the inlet 3B into the inside. Thereby, the sealing material 50 is packed into the inlet 3B as shown in FIG. 1. It is preferable to suppress the leaching of the sealing material 50 to the display section 2 at this time by e.g. the following method: increase in the viscosity of the sealing material 50, narrowing of a cell gap G near the inlet 3B, or suppression of the flowing of the sealing material 50 into the display section 2 by low-temperature sealing. Through the above process, the liquid crystal display device 1 shown in FIG. 1 to FIG. 3 is completed.

As the way of cutting (scribing and breaking) the first substrate 10 and the second substrate 20, e.g. the following way can also be employed. Specifically, the plural display sections 2 are separated on a column-by-column basis in such a manner that the state in which the inlet 3B is exposed to the outer end is obtained. Then, injection of a liquid crystal and packing of the sealing material 50 are performed and thereafter each display section 2 is separated (strip injection).

In the present embodiment, the inlet 3B is provided in a continuous linear manner. Therefore, the inlet 3B is wide and the sealing frame 3A does not need to be provided at this part. Accordingly, the frame size is reduced corresponding to the absence of the sealing frame 3A. In addition, reliability lowering due to superposition of the positional accuracy of the sealing frame 3A and the scribing accuracy (breaking accuracy) is suppressed.

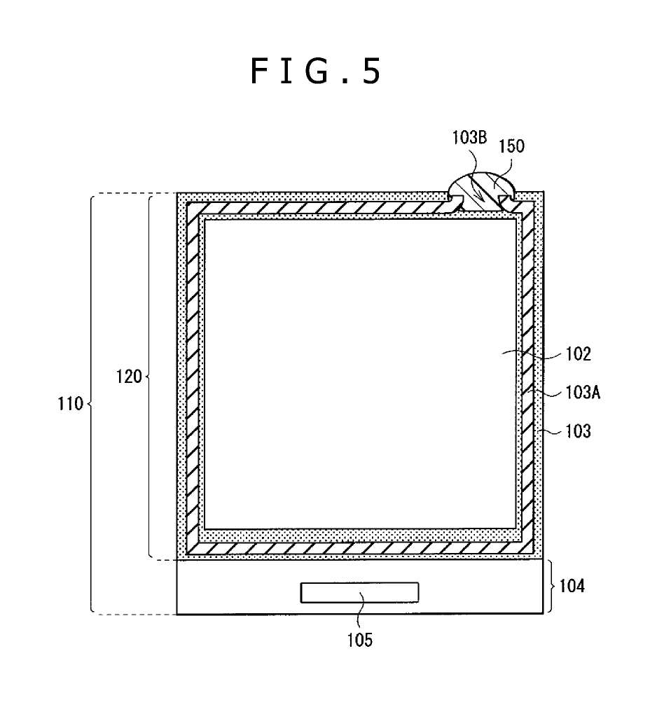

In contrast, in the related art, as shown in FIG. 5, the size of an inlet 103B is set as small as possible so that a liquid crystal may be sealed by a sealing frame 103A. Therefore, there is a limit to reduction in the frame size in terms of the dispensing accuracy of a thermosetting resin in forming the sealing frame 103A and the positional accuracy of the sealing frame 103A. In FIG. 5, the same constituent elements in FIG. 1 are given the same symbols that are in the 100 s.

Furthermore, in the case of scribing the substrate mother material together with the sealing frame like in the related art, the scribing accuracy (breaking accuracy) needs to be considered in addition to the positional accuracy of the sealing frame and it is difficult to ensure the minimum line width of the sealing frame. Moreover, a crack is not made in the sealing frame itself in the scribing step and therefore variation occurs in the way of breaking of the sealing frame in the breaking step. Due to this, the related-art method possibly involves reliability lowering and it is difficult to apply the method to an actual mass-production step.

In this liquid crystal display device 1, when light is incident on the display section 2 from the backlight unit (not shown), this incident light passes through the polarizing plate (not shown) and then is transmitted through the liquid crystal layer 30 with modulation on a pixel-by-pixel basis based on the video voltage applied between the first substrate 10 and the second substrate 20. The light transmitted through the liquid crystal layer 30 passes through the second substrate 20 having the color filter 21 to thereby be extracted to the outside of the polarizing plate (not shown) as color display light.

As described above, in the present embodiment, the inlet 3B is provided in a continuous linear manner and thus the frame size can be reduced with ensuring of the reliability.

### Second Embodiment

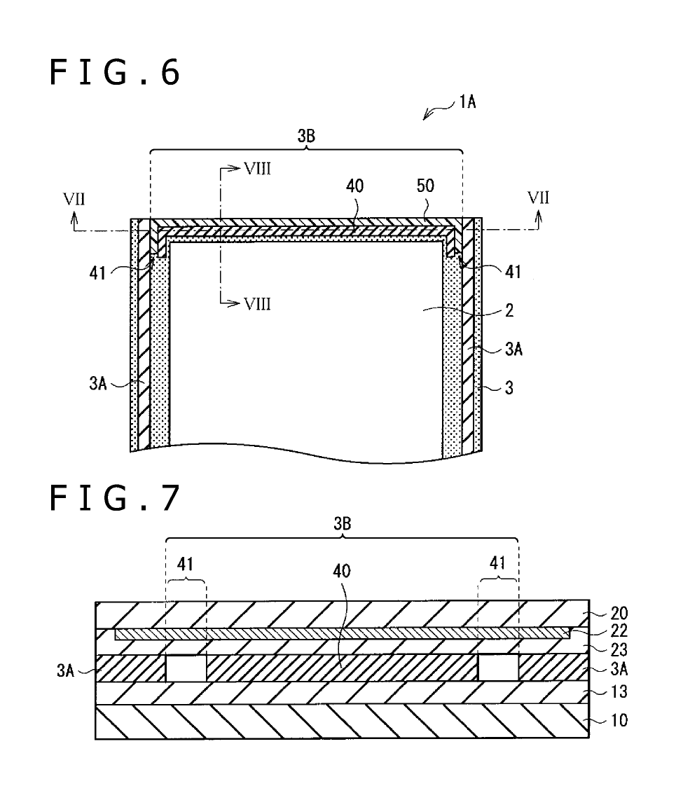

FIG. 6 shows the planar configuration of a liquid crystal display device 1A according to a second embodiment of the present disclosure. FIG. 7 shows a sectional configuration along line VII-VII in FIG. 6 and FIG. 8 shows a sectional configuration along line VIII-VIII in FIG. 6. In the present embodiment, the flow of the sealing material 50 is controlled by providing a weir structure 40 between the inlet 3B and the display section 2. Except for this, this liquid crystal display device 1A has the same configuration, operation and effect as those of the first embodiment.

The weir structure 40 has e.g. a planar shape that forms three sides of a rectangle and is composed of a straight-line part along one side (e.g. upper side, in FIG. 6) of the display section 2 and bent parts at both ends of this straight-line part. Gaps 41 are made between the bent parts at both ends of the weir structure 40 and the sealing frame 3A. Due to this structure, the large part of the inlet 3B is blocked by the weir structure 40 and openings are made only at the gaps 41 at both ends of the inlet 3B. The liquid crystal passes through the gaps 41 to be introduced to the display section 2. The sealing material 50 is packed in the area between the inlet 3B and the weir structure 40 and in the gaps 41. The injection rate and injection amount of the liquid crystal and the sealing material 50 are controlled through adjustment of the width of the gap 41.

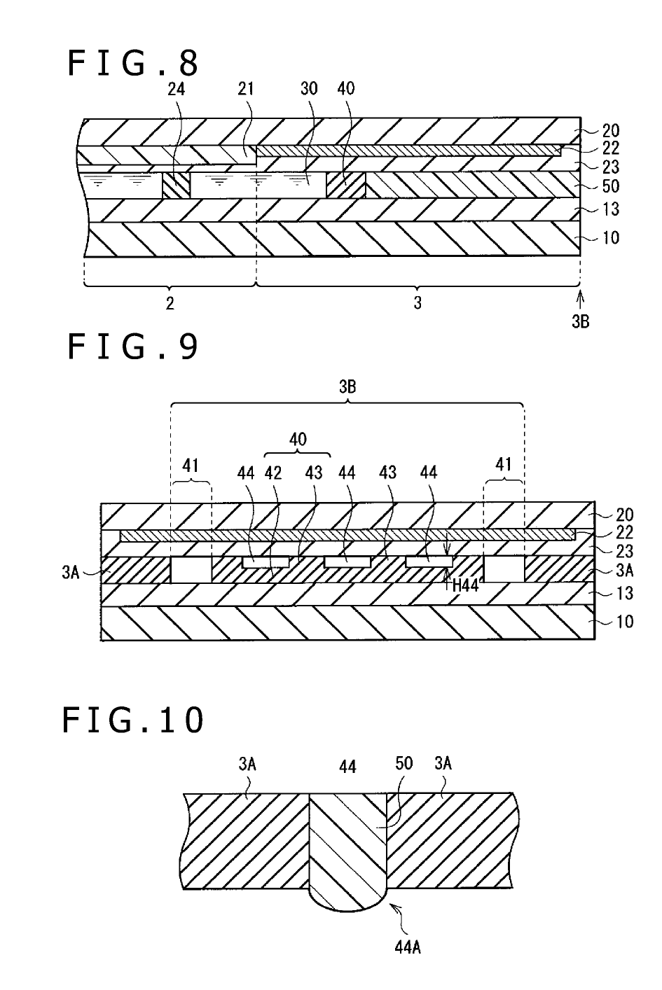

In the present embodiment, drawing of the sealing material 50 is performed in the frame section 3 (gaps 41 at both ends of the inlet 3B) to thereby prevent the sealing material 50 from entering the display section 2. In other words, sealing is performed in the frame section 3. When drawing of the sealing material 50 in a certain time is considered, the sealing material 50 under the presence of the weir structure 40 flows to the frame section 3 preferentially in light of the flow rate even if gaps 44 exist among plural posts 43 as shown in FIG. 9 to be described later. Thus, the sealing material 50 does not enter the display section 2 under such a condition that the area between the weir structure 40 and the end of the first substrate 10 or the second substrate 20 is filled with the sealing material 50. Therefore, the reliability of the liquid crystal display device 1A is obtained if the distance between the weir structure 40 and the end of the first substrate 10 or the second substrate 20 comes up to a thickness of the sealing material 50 being capable of keeping of the reliability.

The constituent material of the weir structure 40 is not particularly limited to an insulating material, a metal, etc. In light of the productivity, it is preferable for the weir structure 40 to be configured by the same layer as another layer over the first substrate 10 or the second substrate 20 like in modification examples 7 to 9 to be described later.

FIG. 9 shows another example of the sectional configuration along line VII-VII in FIG. 6. The weir structure 40 has a wall 42 and the plural posts 43. The wall 42 extends over the first substrate 10 in the direction perpendicular to entry direction A1 of the sealing material 50. The plural posts 43 are provided between the top surface of the wall 42 and the second substrate 20. The liquid crystal passes through the gaps 41 at both ends and the gaps 44 among the plural posts 43 to be introduced to the display section 2. The sealing material 50 stops at exits 44A of the gaps 44 among the plural posts 43 due to the force of the interface as shown in FIG. 10 for example. This force of the interface depends on the liquid crystal material, the material of the sealing material 50, and the material of the weir structure 40.

It is preferable for the weir structure 40 shown in FIG. 9 to be in contact with both the first substrate 10 and the second substrate 20. This can suppress variation in size H44 of the gap 44 on a case-by-case basis in injection of the sealing material 50 in a manufacturing step to be described later. Thus, variation in the injection rate, injection time, and injection amount of the sealing material 50 can be reduced. In addition, failure in the injection of the liquid crystal and so forth can also be suppressed.

The weir structure 40 may have the plural posts 43 under the wall 42. Furthermore, it is also possible to provide the plural posts between upper wall and lower wall.

This liquid crystal display device 1A can be manufactured in the following manner for example.

First, the first substrate 10 composed of e.g. glass is prepared. Over this first substrate 10, a drive circuit and a metal wiring layer (neither is shown), the organic insulating layer 13, a common electrode, an interlayer insulating film, pixel electrodes, and an alignment film (none are shown) are sequentially formed similarly to the first embodiment.

Furthermore, the second substrate 20 composed of e.g. glass is prepared. Over this second substrate 20, the color filter 21, the light blocking film 22, the overcoat layer 23, the spacer layer 24, and an alignment film (not shown) are formed similarly to the first embodiment.

Subsequently, the weir structure 40 having the gaps 41 at both ends of the inlet 3B as shown in FIG. 6 or the weir structure 40 composed of the wall 42 and the plural posts 43 as shown in FIG. 9 is formed. In forming the weir structure 40, it is possible to provide the whole of the weir structure 40 over either one of the first substrate 10 and the second substrate 20. Alternatively, it is also possible to form the weir structure 40 as a layer-laminated structure composed of plural layers and provide these plural layers over both of the first substrate 10 and the second substrate 20 in a divided manner. Details of the latter way will be described later in modification examples 7 to 9.

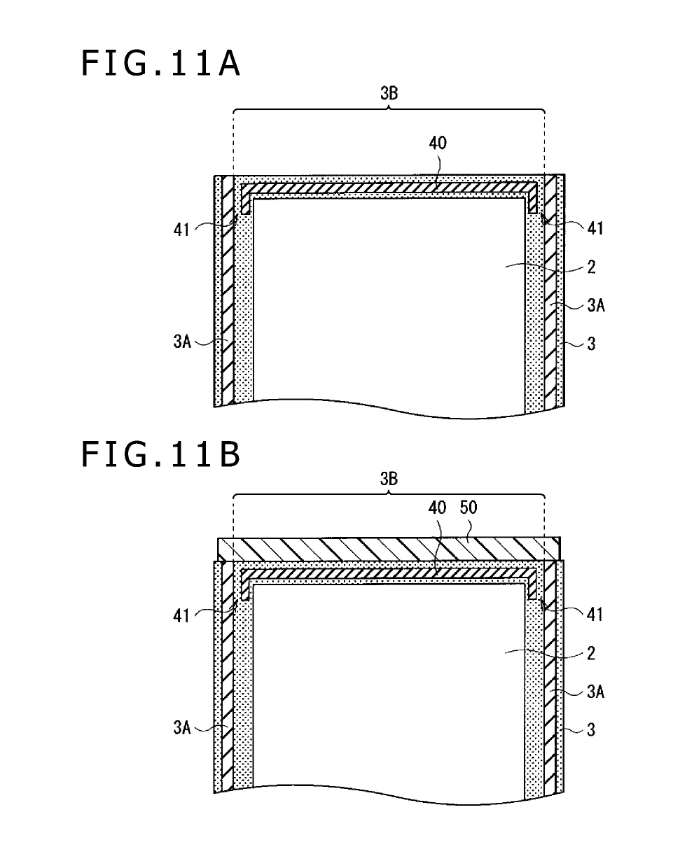

Subsequently, as shown in FIG. 11A, the sealing frame 3A is formed by a thermosetting resin in the frame section 3 of the first substrate 10 for example similarly to the first embodiment. The weir structure 40 is fabricated by photolithography and thus can be formed with accuracy higher than that of the sealing frame 3A, which is fabricated by dispensing. Therefore, it is preferable that the weir structure 40 be formed before fabrication of the sealing frame 3A. Thereafter, the first substrate 10 and the second substrate 20 are disposed opposed to each other with the intermediary of the sealing frame 3A and bonding of the first substrate 10 and the second substrate 20 is performed by curing the thermosetting resin configuring the sealing frame 3A.

Subsequently, a liquid crystal is injected into the gap between the first substrate 10 and the second substrate 20. The liquid crystal passes through the gaps 41 at both ends of the inlet 3B to be introduced to the display section 2.

Thereafter, as shown in FIG. 11B, the sealing material 50 is applied to the inlet 3B in the state in which the pressure of the inside of the sealing frame 3A is reduced, and the sealing material 50 is drawn into the inside of the inlet 3B.

In the present embodiment, because the weir structure 40 is provided between the inlet 3B and the display section 2, the sealing material 50 flows to the gaps 41 in the frame section 3. Thereby, the sealing material 50 is packed into the part from the inlet 3B to the weir structure 40 and the leaching thereof to the display section 2 is suppressed.

In particular, in the configuration of FIG. 9, variation in the size H44 of the gap 44 on a case-by-case basis in injection of the sealing material 50 is absent because the weir structure 40 is in contact with both of the first substrate 10 and the second substrate 20. Thus, variation in the injection rate, injection time, and injection amount of the sealing material 50 is small. Furthermore, failure in the injection of the liquid crystal and so forth is also suppressed. Through the above process, the liquid crystal display device 1A shown in FIG. 6 to FIG. 8 is completed.

In this liquid crystal display device 1A, when light is incident on the display section 2 from the backlight unit (not shown), this incident light is transmitted through the liquid crystal layer 30 with modulation on a pixel-by-pixel basis and then passes through the color filter 21 to be extracted to the outside of the polarizing plate (not shown) as color display light similarly to the first embodiment.

In the present embodiment, because the weir structure 40 is provided between the inlet 3B and the display section 2, the leaching of the sealing material 50 to the display section 2 is suppressed and display failure attributed to it is suppressed.

As described above, in the present embodiment, the weir structure 40 is provided between the inlet 3B and the display section 2. Thus, it is possible to control the flow of the sealing material 50 by this weir structure 40 and suppress the leaching of the sealing material 50 to the display section 2.

Although the configuration in which the gaps 41 are made at both ends of the inlet 3B is described in the present embodiment, the position of the gaps 41 is not limited to both ends of the inlet 3B and the gaps 41 may be made at another position such as the center part of the weir structure 40.

### MODIFICATION EXAMPLE 1

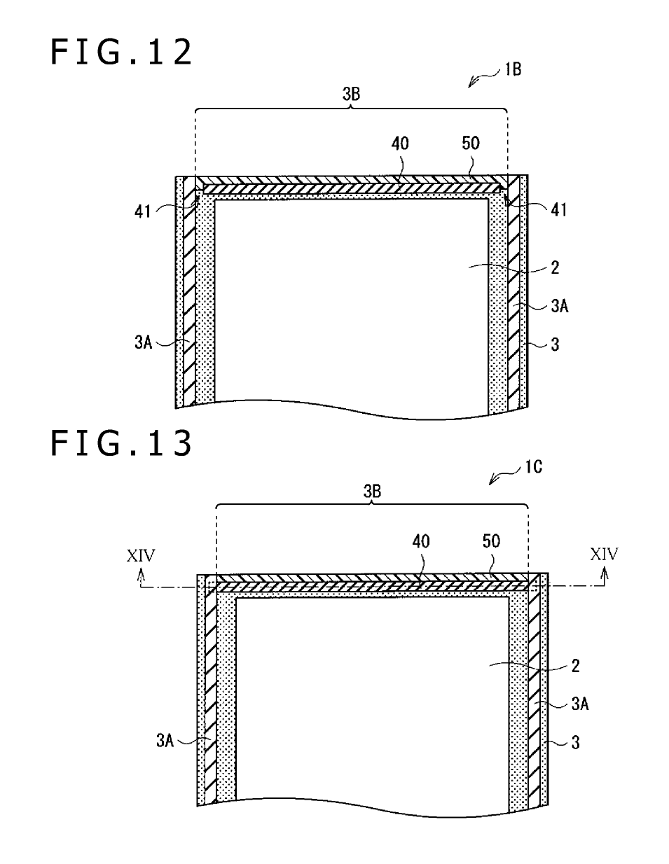

FIG. 12 shows the planar configuration of a liquid crystal display device 1B according to modification example 1. This liquid crystal display device 1B has the same configuration, operation and effect as those of the second embodiment except for that the weir structure 40 is provided in a straight line manner along the upper side of the display section 2, and can be manufactured similarly to the second embodiment.

### MODIFICATION EXAMPLE2

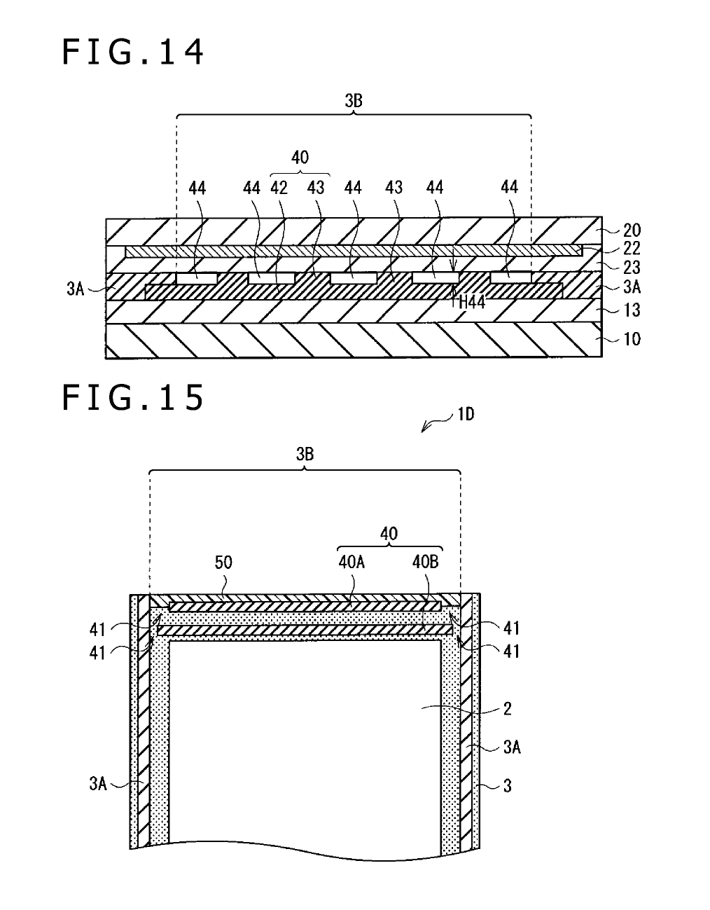

FIG. 13 shows the planar configuration of a liquid crystal display device 1C according to modification example 2 and FIG. 14 shows a sectional configuration along line XIV-XIV in FIG. 13. The present modification example has the same configuration and operation and effect as those of the second embodiment except for that the weir structure 40 is provided in a straight line manner along the upper side of the display section 2 and the end parts of the sealing frame 3A are overlaid on the end parts of the weir structure 40. The present modification example can be manufactured similarly to the second embodiment.

In the case of stacking the end parts of the weir structure 40 and the end parts of the sealing frame 3A like in the present modification example, it is preferable for the weir structure 40 to have the wall 42 and the plural posts 43 as described with reference to FIG. 9 for the second embodiment. In this case, the liquid crystal passes through the gaps 44 among the plural posts 43 to be introduced to the display section 2. The sealing material 50 stops at the exits 44A of the gaps 44 among the plural posts 43 due to the force of the interface as described with reference to FIG. 10 for the second embodiment. This force of the interface depends on the liquid crystal material, the material of the sealing material 50, and the material of the weir structure 40.

It is preferable for the weir structure 40 to be in contact with both of the first substrate 10 and the second substrate 20 similarly to the second embodiment. This can suppress variation in the size H44 of the gap 44 on a case-by-case basis in injection of the sealing material 50 in the manufacturing step. Furthermore, the gap 44 of the weir structure 40 is controlled on the order of several micrometers by photolithography and thus variation in the sealing amount is suppressed. In contrast, in the case of the configuration of FIG. 7 of the second embodiment, control is difficult and variation is suppressed by performing sealing in the frame section 3 because the line width accuracy and positional accuracy of the sealing frame 3A are on the order of several hundreds of micrometers.

### MODIFICATION EXAMPLE3

FIG. 15 shows the planar configuration of a liquid crystal display device 1D according to modification example 3. In the present modification example, two weir structures 40A and 40B are provided at two positions at different distances from the inlet 3B. By doubly disposing the weir structures 40A and 40B between the inlet 3B and the display section 2 in this manner, the sealing material 50 that has passed through the outside weir structure 40A can be stopped by the inside weir structure 40B as the backup and the leaching of the sealing material 50 to the display section 2 can be surely suppressed. This liquid crystal display device 1D has the same configuration, operation and effect as those of the second embodiment except for this, and can be manufactured similarly to the second embodiment.

### MODIFICATION EXAMPLE4

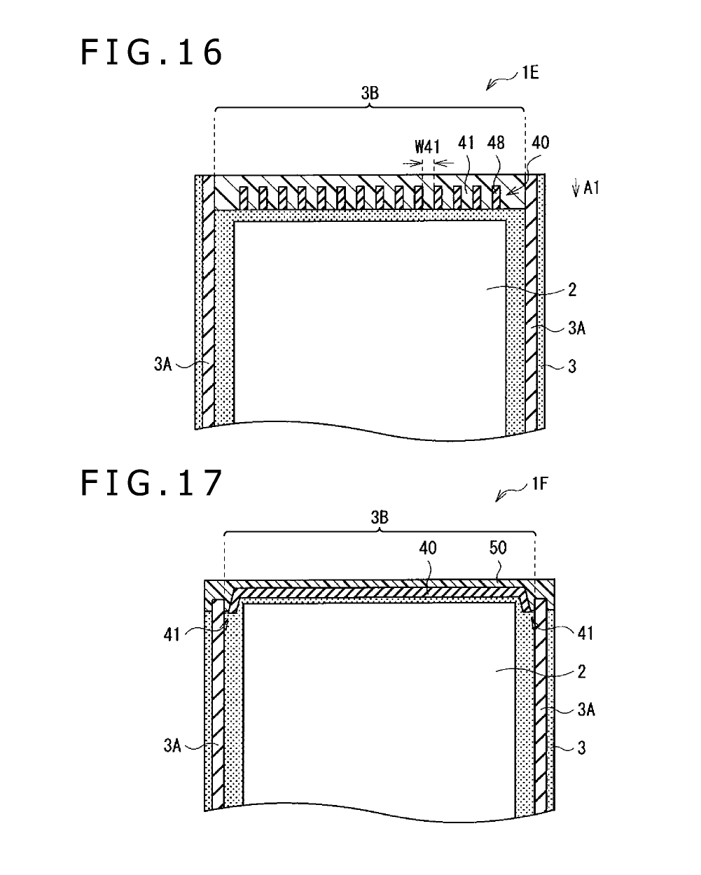

FIG. 16 shows the planar configuration of a liquid crystal display device 1E according to modification example 4. In this liquid crystal display device 1E, the weir structure 40 has plural walls 48 provided along a direction that is not perpendicular to the entry direction A1 of the sealing material 50 between the first substrate 10 and the second substrate 20. This liquid crystal display device 1E has the same configuration, operation and effect as those of the second embodiment except for this, and can be manufactured similarly to the second embodiment.

For example, the walls 48 are juxtaposed along the direction parallel to the entry direction A1 of the sealing material 50 as shown in FIG. 16. The liquid crystal passes through the gaps 41 among the plural walls 48 to be introduced to the display section 2. By adjusting the width of the gap 41, the injection rate and injection amount of the sealing material 50 are controlled similarly to the second embodiment. In this case, the sealing material 50 is stopped by the force of the interface and friction and therefore it is preferable that the width W41 of the gap 41 be several micrometers to several tens of micrometers. Furthermore, it is also effective to increase the distance from the display section 2 by providing the wall 48 with a bent part or making the wall 48 oblique to the entry direction A1 of the sealing material 50.

### MODIFICATION EXAMPLE5

FIG. 17 shows the planar configuration of a liquid crystal display device 1F according to modification example 5. In this liquid crystal display device 1F, the ends of the sealing frame 3A are made to recede toward the inside from the outer shape line of the first substrate 10 and the second substrate 20 and the receding parts of the sealing frame 3A are covered by providing bent parts at both ends of the weir structure 40. The liquid crystal passes through the gaps 41 at both ends of the weir structure 40 to be introduced to the display section 2. This liquid crystal display device 1F has the same configuration, operation and effect as those of the second embodiment except for this, and can be manufactured similarly to the second embodiment.

### MODIFICATION EXAMPLE6

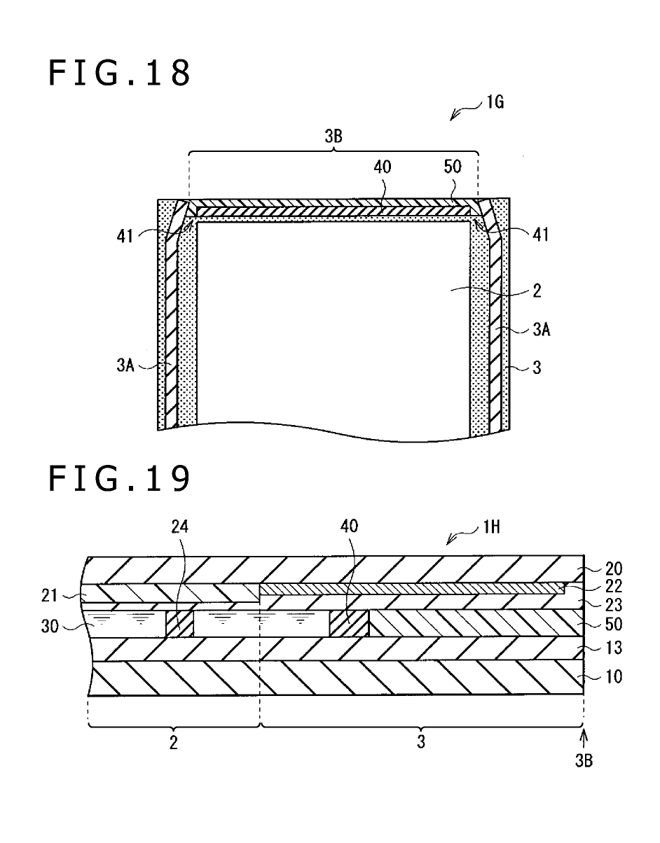

FIG. 18 shows the planar configuration of a liquid crystal display device 1G according to modification example 6. In the present modification example, oblique parts are provided at the ends of the sealing frame 3A. As just described, it is also possible to provide oblique parts or rounded parts at the ends of the sealing frame 3A if the frame section 3 has enough size. This liquid crystal display device 1G has the same configuration, operation and effect as those of the second embodiment except for this, and can be manufactured similarly to the second embodiment.

### MODIFICATION EXAMPLES 7 to 9

In all of the following modification examples 7 to 9, the weir structure 40 is configured by the same layer as another layer that configures the display section 2. This makes it possible to form the weir structure 40 without increasing the number of steps.

### MODIFICATION EXAMPLE7

FIG. 19 shows the sectional configuration of the weir structure 40 of a liquid crystal display device 1H according to modification example 7. The present modification example has the same configuration, operation and effect as those of the second embodiment except for that the weir structure 40 is configured by the same layer as the spacer layer 24 of the display section 2, and can be manufactured similarly to the second embodiment.

### MODIFICATION EXAMPLE8

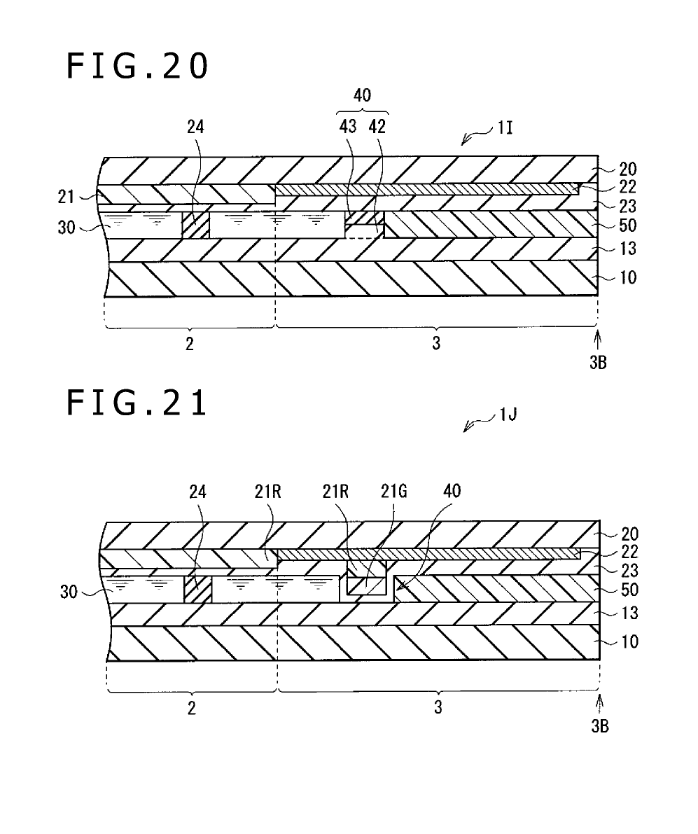

FIG. 20 shows the sectional configuration of the weir structure 40 of a liquid crystal display device 1I according to modification example 8. In the present modification example, the weir structure 40 is configured by the same layers as the spacer layer 24 of the display section 2 and the organic insulating layer 13. This liquid crystal display device 1I has the same configuration, operation and effect as those of the second embodiment except for this, and can be manufactured similarly to the second embodiment.

If the weir structure 40 has the wall 42 and the plural posts 43, it is possible to configure the plural posts 43 by the same layer as the spacer layer 24 of the display section 2 and configure the wall 42 by the same layer as the organic insulating layer 13 as shown in FIG. 20 for example. Furthermore, although not shown in the diagram, it is also possible to configure the wall 42 by the same layer as the spacer layer 24 of the display section 2 and configure the plural posts 43 by the same layer as the organic insulating layer 13. It is preferable that the organic insulating layer 13 on the side of the inlet 3B be removed. This is because higher reliability is obtained.

### MODIFICATION EXAMPLE9

FIG. 21 shows the sectional configuration of the weir structure 40 of a liquid crystal display device 1J according to modification example 9. This liquid crystal display device 1J has the same configuration, operation and effect as those of the second embodiment except for that the weir structure 40 is configured by stacking the same layers as a red filter 21R, a green filter 21G, and the overcoat layer 23. The liquid crystal display device 1J can be manufactured similarly to the second embodiment.

### MODIFICATION EXAMPLE10

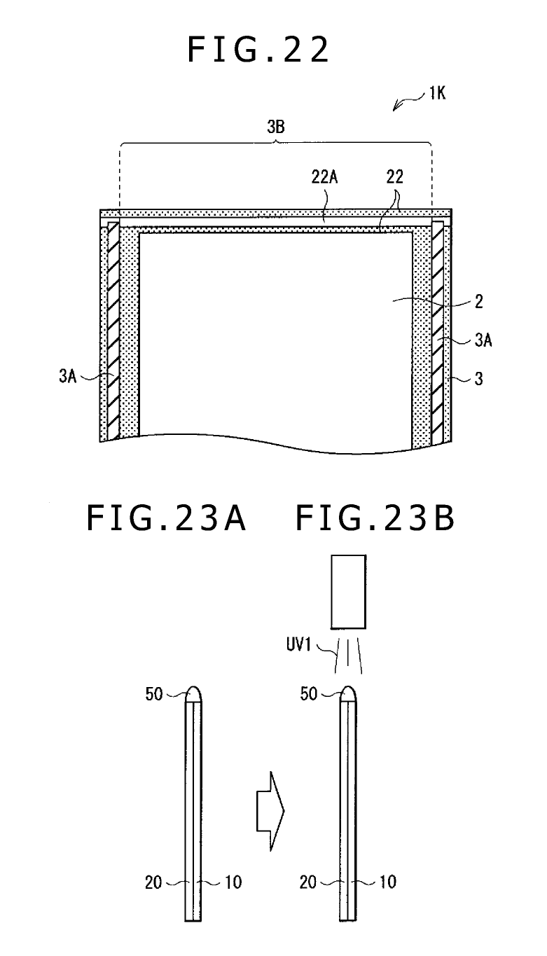

FIG. 22 shows the planar configuration of a liquid crystal display device 1K according to modification example 10. In the present modification example, a light window 22A is provided in the light blocking film 22 instead of the weir structure 40 to thereby surely suppress the influence of the sealing material 50 on the display section 2. In particular, the present modification example is suitable for the case in which the weir structure 40 is not provided like in the first embodiment. Except for this, this liquid crystal display device 1K has the same configuration, operation and effect as those of the first embodiment. If light leakage of the backlight is a problem, it is preferable to carry out light blocking on a single-side substrate, specifically e.g. by a metal film in the case of the array side (first substrate 10) and by the light blocking film 22 as the black matrix in the case of the opposing side (second substrate 20).

FIG. 23 shows the major part of a manufacturing method of the liquid crystal display device 1K shown in FIG. 22 in the step order. First, the first substrate 10 composed of e.g. glass is prepared. Over this first substrate 10, a drive circuit and a metal wiring layer (neither is shown), the organic insulating layer 13, a common electrode, an interlayer insulating film, pixel electrodes, and an alignment film (none are shown) are sequentially formed similarly to the first embodiment.

Furthermore, the second substrate 20 composed of e.g. glass is prepared. Over this second substrate 20, the color filter 21, the light blocking film 22, the overcoat layer 23, the spacer layer 24, and an alignment film (not shown) are formed similarly to the first embodiment.

Subsequently, the sealing frame 3A is formed by a thermosetting resin in the frame section 3 of the first substrate 10 for example similarly to the first embodiment. Thereafter, the first substrate 10 and the second substrate 20 are disposed opposed to each other with the intermediary of the sealing frame 3A and bonding of the first substrate 10 and the second substrate 20 is performed by curing the thermosetting resin configuring the sealing frame 3A.

Subsequently, a liquid crystal is injected into the gap between the first substrate 10 and the second substrate 20. The liquid crystal passes through the inlet 3B to be introduced to the display section 2.

Thereafter, as shown in FIG. 23A, the sealing material 50 is applied to the inlet 3B in the state in which the pressure of the inside of the sealing frame 3A is reduced, and the sealing material 50 is drawn into the inside of the inlet 3B.

At this time, as shown in FIG. 23B, ultraviolet UV1 is irradiated from above the sealing material 50. The sealing material 50 is cured at the timing when it reaches the light window 22A before entering the display section 2 due to the oblique travel and entry of the ultraviolet UV1. Thus, the sealing material 50 is packed into the part from the inlet 3B to the light window 22A and the leaching thereof to the display section 2 is suppressed. If the oblique travel and entry of the ultraviolet UV1 is insufficient, it is possible to suppress the leaching of the sealing material 50 to the display section 2 by inclining the ultraviolet UV1 or the panel to thereby increase the light amount of ultraviolet UV1 irradiated to the light window 22A.

### MODIFICATION EXAMPLE11 TO MODIFICATION EXAMPLE13

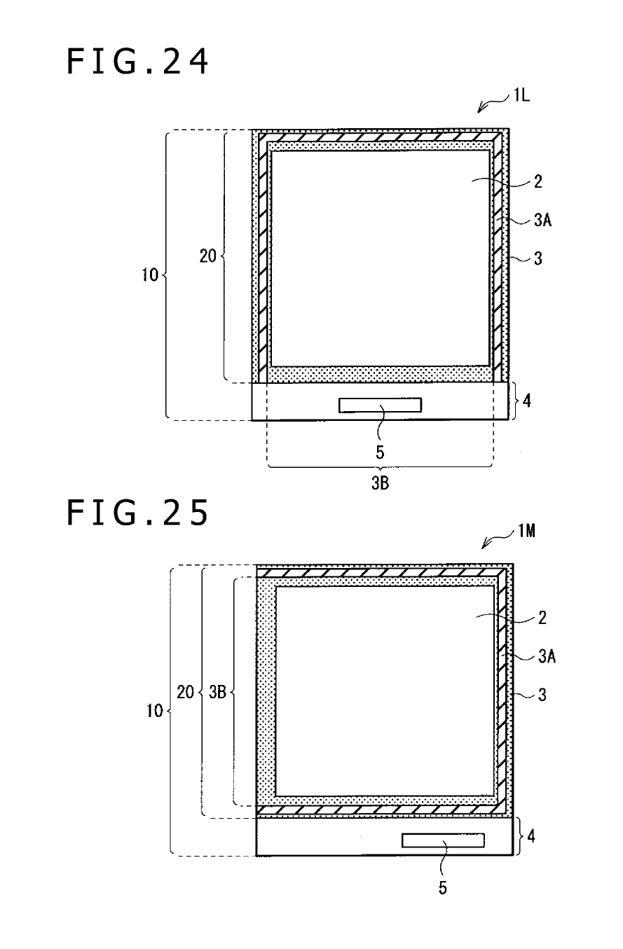

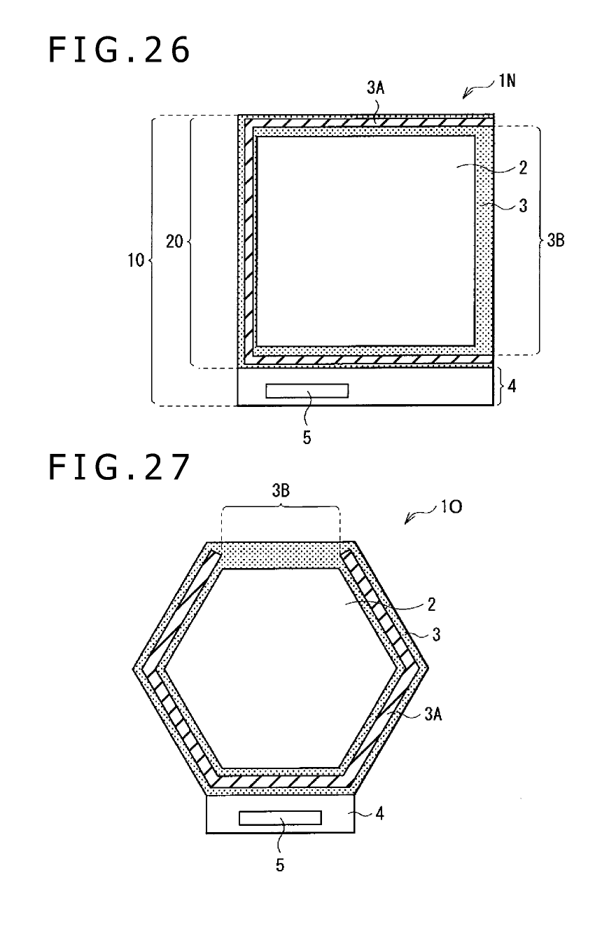

FIG. 24 to FIG. 26 show the planar configurations of liquid crystal display devices 1L, 1M, and 1N according to modification examples 11 to 13. In the present modification examples, the inlet 3B is provided along the lower side, the left side, and the right side, respectively, of the display section 2. It is obvious that the weir structure 40 of the second embodiment can be provided between the inlet 3B and the display section 2. The liquid crystal display devices 1L, 1M, and 1N have the same configuration, operation and effect as those of the first or second embodiment except for this, and can be manufactured similarly to the first or second embodiment.

### MODIFICATION EXAMPLE14

FIG. 27 shows the planar configuration of a liquid crystal display device 10 according to modification example 14. In this liquid crystal display device 10, the first substrate 10 and the second substrate 20 each have a hexagonal shape and the inlet 3B is provided across the whole of one side (e.g. upper side, in FIG. 27) of the display section 2. It is obvious that the weir structure 40 of the second embodiment can be provided between the inlet 3B and the display section 2. This liquid crystal display device 10 has the same configuration, operation and effect as those of the first or second embodiment except for this, and can be manufactured similarly to the first or second embodiment.

The exposed area 4 protruded out from the second substrate 20 is provided along one side (e.g. lower side, in FIG. 27) of the first substrate 10 and the external connection terminal 5 is provided in this exposed area 4.

Although the case in which the first substrate 10 and the second substrate 20 each have a hexagonal shape is described in the present modification example, the present modification example can be applied also to the case in which the first substrate 10 and the second substrate 20 each have a rectangular shape (quadrangular shape) or a polygonal shape other than the hexagonal shape. That is, also when the first substrate 10 and the second substrate 20 each have a rectangular shape (quadrangular shape) or a polygonal shape other than the hexagonal shape, it is preferable for the inlet 3B to be equivalent to or larger than one side of the display section 2 in size.

### MODIFICATION EXAMPLE15

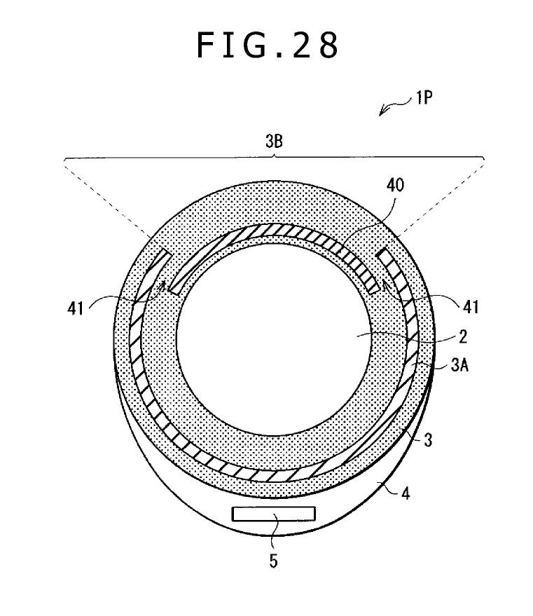

FIG. 28 shows the planar configuration of a liquid crystal display device 1P according to modification example 15. In this liquid crystal display device 1P, the first substrate 10 and the second substrate 20 each have a circular shape and the inlet 3B is provided in a continuous circular arc manner along part (e.g. upper part, in FIG. 28) of the outer shape line of the first substrate 10 and the second substrate 20. It is obvious that the weir structure 40 of the second embodiment can be provided between the inlet 3B and the display section 2. The present modification example has the same configuration, operation and effect as those of the first or second embodiment except for this, and can be manufactured similarly to the first or second embodiment.

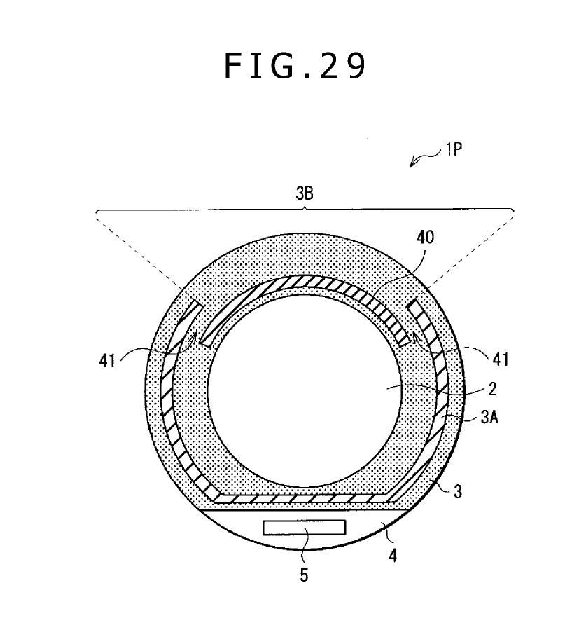

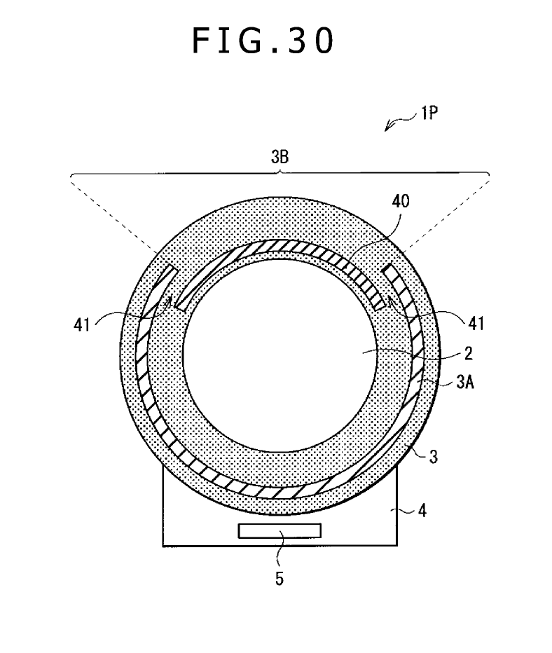

The exposed area 4 protruded out from the second substrate 20 is provided along part (e.g. lower part, in FIG. 28) of the first substrate 10 and the external connection terminal 5 is provided in this exposed area 4. The exposed area 4 has e.g. a crescent shape surrounded by the outer shape line of the first substrate 10 in a circular arc manner and the outer shape line of the second substrate 20 in a circular arc manner. The shape of the exposed area 4 is not limited to the crescent shape shown in FIG. 28. As shown in FIG. 29, it may have a half-moon shape surrounded by the outer shape line of the first substrate 10 in a straight line manner and the outer shape line of the second substrate in a circular arc manner. Alternatively, as shown in FIG. 30, the exposed area 4 may have a shape surrounded by the outer shape line of the first substrate 10 in a circular arc manner and the outer shape line of the second substrate 20 with a shape forming three sides of a rectangle.

Although the present disclosure is explained above by taking embodiments, the present disclosure is not limited to the above-described embodiments and various modifications are possible. For example, although the case in which the display section 2 has a FFS configuration is explained in the above-described embodiments, it may have another configuration such as a twisted nematic (TN) configuration or a vertically aligned (VA) configuration.

Furthermore, for example, the materials and thicknesses or the film deposition methods and film deposition conditions of the respective layers explained in the above-described embodiments are not limited and other materials and thicknesses may be employed or other film deposition methods and film deposition conditions may be employed. For example, the first substrate 10 and the second substrate 20 may be, besides glass, a silicon (Si) substrate, a plastic substrate, or a substrate of another material with the surface kept as an insulating surface.

Moreover, for example, although explanation is made by specifically taking the configurations of liquid crystal display devices in the above-described embodiments, all constituent elements do not need to be included and another constituent element may be further included.

The display device according to the embodiment of the present disclosure can be mainly applied to liquid crystal panels in the category called the middle- and small-size panels. Specific application examples include monitors of mobile apparatus and AV apparatus such as cellular phones, smartphones, digital cameras, portable DVD/Blu-ray viewers, and portable game machines. The examples further include car navigation devices, photo frames, and small notebook personal computers. In particular, applying the display device to e.g. cellular phones or smartphones is advantageous in terms of reduction in the frame size.

It is also possible for the present technique to take the following configurations.

(1) A liquid crystal display device including:

a display section configured to have a liquid crystal layer between a pair of substrates; and

a frame section configured to be provided at a peripheral part of the pair of substrates, wherein

the frame section has an inlet for liquid crystal injection and the inlet is provided in a continuous linear manner.

(2) The liquid crystal display device according to the above-described (1), wherein

the pair of substrates and the display section each have a polygonal shape and the inlet is provided along whole of one side of the display section.

(3) The liquid crystal display device according to the above-described (1) or (2), wherein

the frame section includes
a weir structure that has a gap and is provided between the inlet and the display section, and
a sealing material packed in an area from the inlet to the weir structure.

(4) The liquid crystal display device according to the above-described (3), wherein

the weir structure has
a wall provided over at least one of the pair of substrates, and
a plurality of posts provided on the wall.

(5) The liquid crystal display device according to the above-described (3) or (4), wherein

the weir structure is provided at two or more positions at different distances from the inlet.

(6) The liquid crystal display device according to the above-described (3), wherein

the weir structure has a plurality of walls provided along a direction that is not perpendicular to entry direction of the sealing material between the pair of substrates.

(7) The liquid crystal display device according to any one of the above-described (3) to (6), wherein

the weir structure is configured by the same layer as another layer configuring the display section.

(8) A manufacturing method of a liquid crystal display device including a display section having a liquid crystal layer between a pair of substrates and a frame section provided at a peripheral part of the pair of substrates, the method including:

providing an inlet in a continuous linear manner in the frame section; and injecting a liquid crystal from the inlet into a gap between the pair of substrates.

(9) The manufacturing method of a liquid crystal display device according to the above-described (8), wherein

a polygonal shape is employed as a shape of each of the pair of substrates and the inlet is provided along whole of one side of the pair of substrates.

(10) The manufacturing method of a liquid crystal display device according to the above-described (8) or (9), further including:

forming a weir structure having a gap between the inlet of the frame section and the display section; and

providing a sealing material at part from the inlet to the weir structure.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A liquid crystal display device comprising:
a display section configured to have a liquid crystal layer between a pair of substrates; and
a frame section configured to be provided at a peripheral part of the pair of substrates, wherein
the frame section has an inlet for liquid crystal injection and the inlet is provided in a continuous linear manner.

2. The liquid crystal display device according to claim 1, wherein
the pair of substrates and the display section each have a polygonal shape and the inlet is provided along whole of one side of the display section.

3. The liquid crystal display device according to claim 1, wherein
the frame section includes
a weir structure that has a gap and is provided between the inlet and the display section, and
a sealing material packed in an area from the inlet to the weir structure.

4. The liquid crystal display device according to claim 3, wherein
the weir structure has
a wall provided over at least one of the pair of substrates, and
a plurality of posts provided on the wall.

5. The liquid crystal display device according to claim 3, wherein
the weir structure is provided at two or more positions at different distances from the inlet.

6. The liquid crystal display device according to claim 3, wherein
the weir structure has a plurality of walls provided along a direction that is not perpendicular to entry direction of the sealing material between the pair of substrates.

7. The liquid crystal display device according to claim 3, wherein
the weir structure is configured by the same layer as another layer configuring the display section.

8. A manufacturing method of a liquid crystal display device including a display section having a liquid crystal layer between a pair of substrates and a frame section provided at a peripheral part of the pair of substrates, the method comprising:
providing an inlet in a continuous linear manner in the frame section; and
injecting a liquid crystal from the inlet into a gap between the pair of substrates.

9. The manufacturing method of a liquid crystal display device according to claim 8, wherein
a polygonal shape is employed as a shape of each of the pair of substrates and the inlet is provided along whole of one side of the pair of substrates.

10. The manufacturing method of a liquid crystal display device according to claim 8, further comprising:
forming a weir structure having a gap between the inlet of the frame section and the display section; and
providing a sealing material at part from the inlet to the weir structure.
